(19) United States
(12) Patent Application Publication
(10) Pub. No.: US 2006/0052226 A1
(43) Pub. Date: Mar. 9, 2006

(54) Injection of a medium into a filter segment

(75) Inventors: Andreas Rinke, Bad Oldesloe (DE); matthias Jahnke, Hamburg (DE); Sonke Horn, Geesthacht (DE); Thorsten Scherbarth, Geesthacht (DE)

Correspondence Address: VENABLE LLP, P.O. BOX 34385, WASHINGTON, DC, 20045-9998, US

(73) Assignee: HAUNI MASCHINENBAU AG, HAMBURG (DE)

(21) Appl. No.: 10/526,772

(22) PCT Filed: Jul. 16, 2003
(86) PCT No.: PCT/EP03/07678

§ 371 Date: Mar. 8, 2005

(30) Foreign Application Priority Data
Sep. 11, 2002 (EP) 02020289.1

(51) Int. Cl. B31C 13/00

(52) U.S. Cl. 493/39

(57) ABSTRACT

The invention relates to a method for producing multi-segment filters for the tobacco processing industry, wherein filter rods or filter segments are delivered to a form a group of filter segments. The method includes introducing a medium into the filter rods or filter segments before the filter rods or filter segments are delivered to the formed group of filter segments. The invention also relates to a module of a multi-segment filter machine for the tobacco processing industry, wherein filter rods or filter segments can be delivered to form a group of filter segments. The invention further relates to a multi-segment filter machine for the tobacco processing industry.

The invention relates to a method for producing multi-segment filters in the tobacco-processing industry, wherein filter segments are delivered to a group of filter segments. The invention furthermore relates to a module on a multi-segment filter maker in the tobacco-processing industry, wherein filter segments can be delivered to a group of filter segments, as well as to a multi-segment filter maker in the tobacco-processing industry.

A device for injecting flowable mediums into articles of smoking is disclosed in German Patent DE-C-100 52 409. However, this device is suitable only for injecting mediums during the individual processing of articles for the test and laboratory operation. For this, an article of smoking and in particular a cigarette is transferred and enclosed inside a holder, wherein the holder is designed to rotate around the longitudinal axis for introducing a medium, e.g. flavoring agents or a liquid flavoring, while the cigarette is rotating. The device disclosed in this reference can be used only for the individual processing of articles of smoking and is not suitable for use in the (mass) production of smoking articles.

The tobacco-processing industry, however, has the desire to produce multi-segment filters, assembled with different filter segments that may consist of different types of materials, for example cellulose acetate, paper, non-woven, granulate, separate elements, hollow cylinder or hollow-chamber segments, capsules and the like. Multi-segment filters of this type, which for the purpose of this invention also include “multifilters,” are wrapped by means of the continuous-rod forming method with a wrapping material, for example paper, after the groups are formed and are then cut for the further processing into filter rods of double the length, four times the length, or six times the length.

German Patent Application DE 101 55 292.0 discloses a device for assembling groups of filter segments for producing multi-segment filters in the tobacco-processing industry, using a continuous rod-forming method, wherein at least two different types of filter segments are provided for each multi-segment filter and wherein the device can be divided into a plurality of independent operating units.

A greater variability in the multi-segment filter production is consequently possible.

It is the object of the present invention to make available filter segments for a multi-segment filter, which can be produced and packaged easily and variably, while the apparatus expenditure is simultaneously kept low.

This object is solved with the aforementioned method, which is further modified by introducing a medium into the filter segments before they are delivered to the group of filter segments. During the continuous multi-segment filter production, a substance is injected into the filter segments which are then used in a following step for assembling a multi-segment filter. The injection of substances provides the filter segments with specific and desired characteristics, so that the filter segments can be adapted easily to the requirements for a multi-segment filter to be produced.

According to one alternative solution, this object is solved using the aforementioned method by initially introducing a medium into filter rods and then, in a subsequent step, cutting the filter rods into filter segments. In the process, the filter rods are removed from a magazine, e.g. a module, and are provided with a substance before they are cut into several segments, wherein this process furthermore takes place during the continuous multi-segment filter production.

The medium is introduced in particular during the transport of the filter rods or filter segments, especially on a conveying drum or operating drum, thus preventing any interruption of the continuous filter-production operation.

To permit a targeted injection of the substances into the filter segments or filter rods, the filter rods or filter segments are held or secured in place before the medium is introduced, thus preventing a slipping of the filter segments or filter rods.

According to a different advantageous embodiment, a predetermined amount of the medium is introduced into the filter rods or filter segments. Through a precise metering of the medium, the filter segments are produced in such a way that they meet all requirements while an efficient use of the medium is simultaneously achieved. Substances such as powdered activated carbon, vitamins, flavoring/ aromatic agents or zeolites, for example, are injected into the filter segments which may consist of cellulose acetate, polypropylene or paper.

Using an injection element, preferably a spray needle, for introducing the medium into the filter segment or filter rod inside results in a good distribution of the substance inside the filter elements. The injection element can additionally be positioned precisely, such that only a specific region of a filter segment is admitted with the medium, for example by injecting a substance into a hollow space inside a filter segment.

According to an alternative embodiment of the invention, it is suggested that the medium be introduced from the outside into the filter segment or filter rods by means of an element, preferably a spray nozzle, in such a way that only an edge region of the filter segment is provided with the medium.

The wrapping material around filter elements is not damaged and remains intact if the medium is introduced parallel to the longitudinal axial direction of the filter segments or filter rods.

The medium is preferably injected into at least one hollow space, preferably in a multifilter segment or multifilter rod.

The object is furthermore solved with a module of the aforementioned type, which is further modified to include a device for introducing a medium into the filter segments.

According to one alternative solution using the aforementioned module, it is proposed that a device for introducing a medium into filter rods be used, as well as a cutting device for cutting the filter rods into filter segments.

According to one modified embodiment, the device in particular is designed to form a part of a conveying means, specifically of a conveying drum or operating drum.

One preferred embodiment comprises a holding element for the filter rods or filter segments, designed to hold in place the filter rods or filter segments before the medium is injected.

According to one embodiment of the present invention, the device is furthermore provided with an element for introducing the medium, preferably a spray nozzle or a spray needle.

It is also advantageous if pressure can be exerted onto the injection element, preferably by means of a compressed-air source or a piston, to achieve a favorable distribution of the injected medium in the filter segment. The use of a compressed-air source additionally results in a good mixing and swirling of the medium.

Furthermore advantageously provided is a metering device for injecting a predetermined amount of the medium into the filter segment.

The object is also solved according to the invention with a multi-segment filter maker in the tobacco-processing industry, said machine comprising a module according to the invention as described in the above.

The invention is described in the following without restricting the general inventive idea by using exemplary embodiments and referring to the drawings, to which we otherwise expressly refer with respect to all details of the invention that are disclosed but not explained in the text. Shown are in:

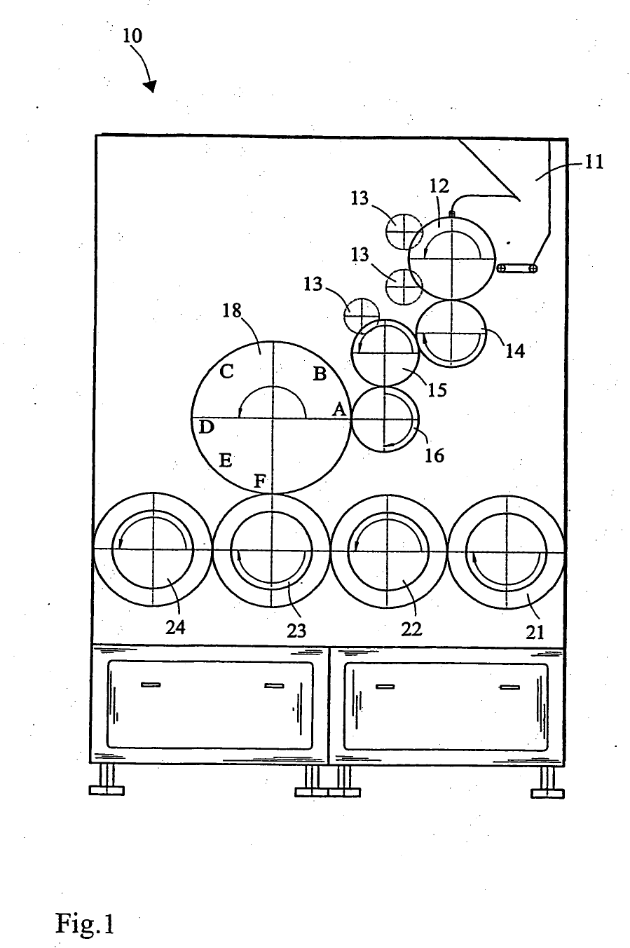

FIG. 1 A view from the front of a module for a multi-segment filter maker;

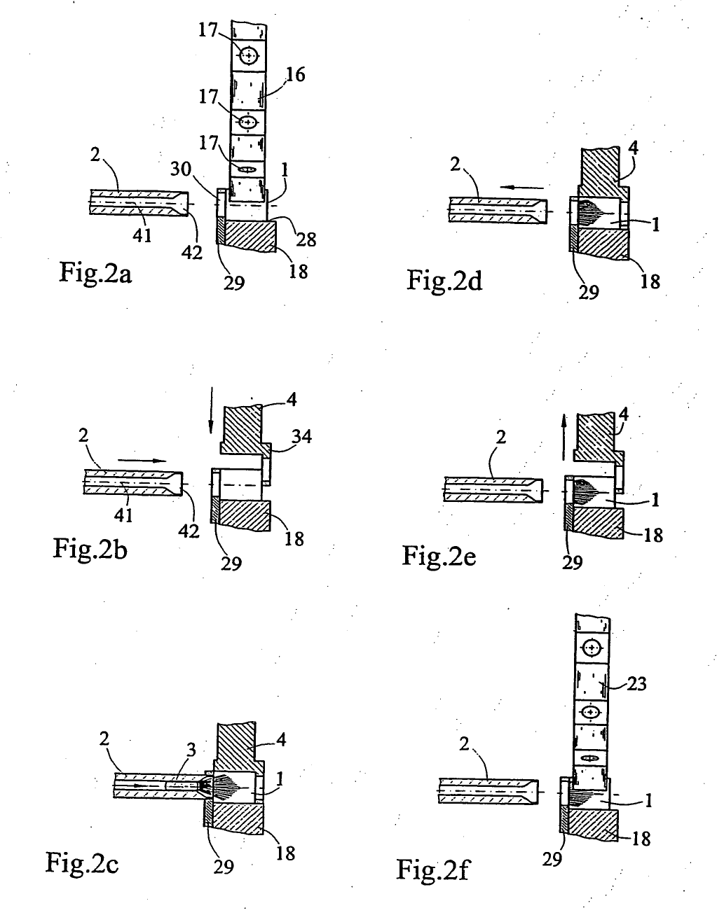

FIGS. 2a-2f A schematic representation of the method steps for injecting a filter segment;

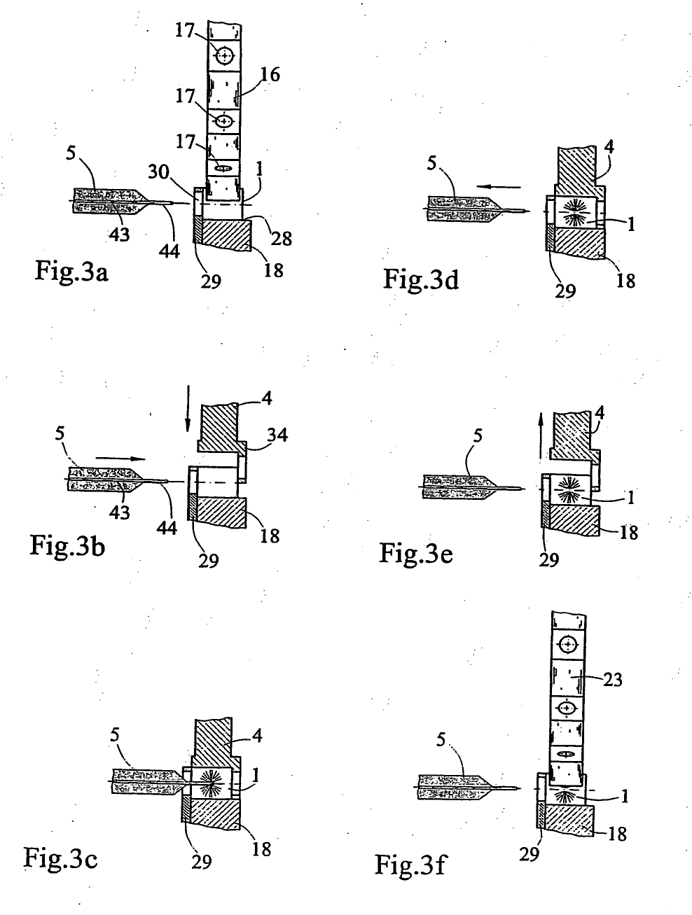

FIGS. 3a-3f A schematic representation of the method steps for directly injecting a filter segment;

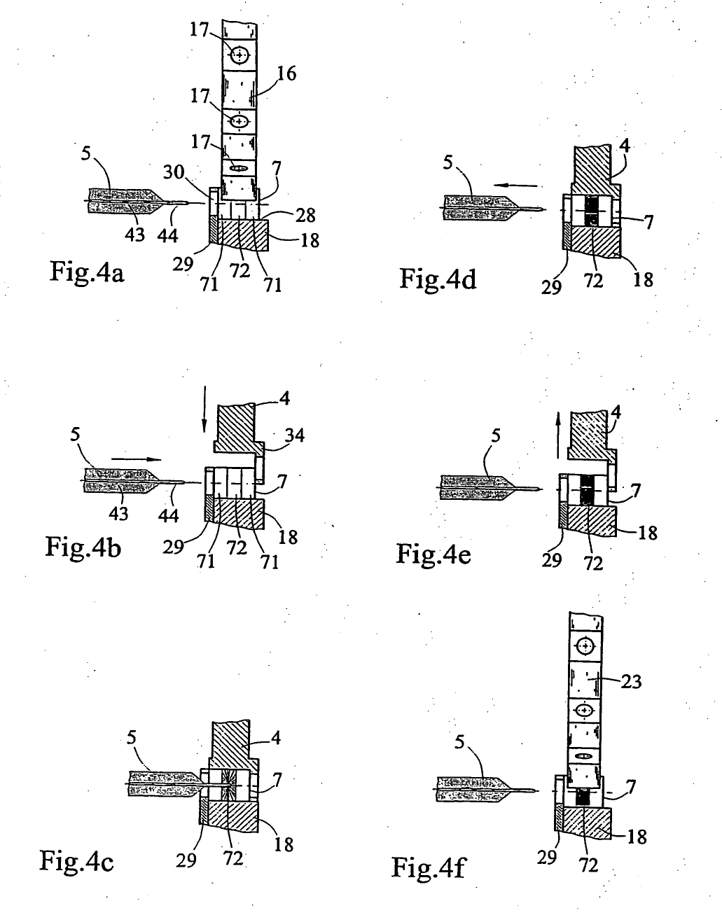

FIGS. 4a-4f A schematic representation of a different sequence of method steps for injecting a medium into the hollow space of a filter.

In the following Figures, identical or corresponding elements are given the same reference numbers and will not be introduced again.

FIG. 1 shows a schematic view from the front of a module 10 for a multi-segment filter maker. This module 10 is suitable for producing filter segments according to the invention which are then processed together with other filter segments from other modules on the multi-segment filter maker to form multi-segment filters.

In the module 10, filter rods that are preferably made of an especially light-weight material such as cellulose acetate are removed by means of a removal drum 12 from a filter magazine 11 and are subsequently cut several times with a knife 13 into multiple filter segments. The cut filter segments are then separated on a separating drum 14 and transferred to a cutting/sliding drum 15 on which the previously cut filter segments are cut again and advanced. The filter segments are subsequently transferred to the insertion/tumbling drum 16 which transfers the cut filter segments to an operating drum 18. According to the invention, the filter segments are injected with at least one medium while positioned on the operating drum 18. Following the injection of a substance into the filter segments, the filter segments are transferred to a transporting drum 23. Additional filter segments are transferred from other modules on the multi-segment filter maker via transporting drums 21, 22 to the transporting drum 23. The filter segments are subsequently fitted together on a transporting drum 24.

According to one embodiment that is not shown herein, the filter rods are injected with a medium immediately after being removed. The filter rods are then cut during subsequent steps into filter segments, such that the filter segments provided with a substance can be used for producing multi-segment filters.

FIGS. 2a to 2f show the individual method steps A to F on the operating drum 18 (see FIG. 1), wherein these are shown as schematic cross-sectional representations. The same applies to the additional, alternative method steps shown in FIGS. 3a to 3f as well as in FIGS. 4a to 4f.

FIG. 2a shows the transfer of a filter segment 1 from a cutting/sliding drum 16 to the operating drum 18. The cutting/sliding drum 16 is provided with suction bores 17 inside the receiving troughs in a further step by means of which the filter segments 1 are held in place on the cutting/sliding drum 16. For the transfer of filter segments 1, the vacuum to the respective suction bores 17 is turned off, so that the filter segment 1 is transferred to a receiving trough 28 in the operating drum 18.

The operating drum 18 is furthermore provided on the side with a limit stop 29 which has a bore 30 in the region of the deposited filter segment 1. A horizontally moving spray nozzle 2 is arranged on the side of the receiving trough 28 and/or the filter segment 1. The spray nozzle 2 comprises a channel 41 which empties into a nozzle head 42. The diameter of nozzle head 42 essentially corresponds to the diameter of the bore 30 in the limit stop 29.

Following the insertion, the filter segment 1 is securely enclosed by a fixing arm 4 inside the receiving trough 28 (FIG. 2b), wherein the fixing arm 4 is preferably designed so as to pivot on the operating drum 18. The fixing arm 4 furthermore has a limit stop 34 on the side, so that the deposited filter segment 1 is held in place in a precise position.

During or following the securing of the filter segment 1, the spray nozzle 2 is advanced from the side against the filter segment 1 and a precisely metered amount of a medium 3, introduced into the channel 41, is blown into the filter segment 1 (FIG. 2c), wherein substances such as zeolites, activated carbon, flavoring/aromatic agents or vitamins can be used for the medium. The spray nozzle 2 is moved in a following step (FIG. 2d) away from the filter segment 1 and the filter segment 1 fixation is released in a further step (FIG. 2e). The finished filter segment 1 is then transferred to the transporting drum 23 (FIG. 2f).

The method steps shown in FIGS. 3a to 3f are analog to the method steps shown in FIGS. 2a to 2h, with the difference that a spray needle 5 is used in place of the spray nozzle 2 (FIGS. 2a to 2f). The spray needle 5 comprises a channel 43 and a needle tip 44 which is inserted parallel to the longitudinal axial direction into the filter segment 1. Once the needle tip 44 enters into the filter segment 1, the medium is injected into the filter segment 1. Within the framework of this invention, it is conceivable that the spray needle 5 can also be provided with several needle tips or that the needle tip 44 has additional (side) discharge openings along the channel 44 to achieve a uniform distribution of the substance inside the filter segment 1.

FIGS. 4a to 4f show a medium being introduced according to the invention into a multifilter segment 7. The multifilter segment 7 comprises outer plugs 71, with a hollow segment 72 disposed in-between. This hollow segment 72 of the multifilter segment. 7 is filled with a substance by means of the spray needle 5. The spray needle 5 in this case is positioned with its needle tip 44 precisely inside the hollow segment 72. Alternatively, hollow spaces in filter rods can also be filled in the same way with a medium.

According to a different modification of the invention, substances are injected from both sides into the filter segments.

### REFERENCE NUMBER LIST

1 filter segment
2 spray nozzle
3 medium
4 fixing arm
5 spray needle
7 multifilter segment
10 module
11 filter magazine
12. removal drum
13 knife
14 separating drum
15 cutting/sliding drum
16 insertion/tumbling drum
17 suction bore
18 operating drum
21 transporting drum
22 transporting drum
23 transporting drum
24 transporting drum
28 receiving trough
29 limit stop
30 bore
41 channel
42 nozzle head
43 channel
44 needle tip
71 plug
72 hollow space

1-17. (canceled)

18. A method for producing multi-segment filters in the tobacco-processing industry comprising:
delivering filter rods or filter segments to form a group of filter segments; and
introducing a medium to the filter rods or filter segments before completion of the delivering step.

19. The method of claim 18, further comprising the step of delivering additional filter rods or filter segments to the formed group of filter segments.

20. The method according to claim 18, further comprising the step of cutting the filter rods into filter segments after the injecting step.

21. The method according to claim 18, wherein the delivering step includes either:
a) transporting the filter rods or filter segments from a magazine to a module, or;
b) transporting the filter rods or filter segments from a magazine through a module; and introducing the medium in the filter rods or filter segments during the transporting step

22. The method according to claim 18 wherein the medium is introduced to the filter rods or filter segments while the filter rods or filter segments are positioned on a conveying drum or operating drum.

23. The method according to claim 18, wherein the filter rods or filter segments are held in place before the medium is introduced.

24. The method according to claim 18, wherein a predetermined amount of the medium is introduced.

25. The method according to claim 18, wherein the medium is introduced by an element for injecting the filter rod or segment or by an element for providing the medium to the outside of the filter rod or segment.

26. The method according to claim 25, wherein the element is an injection needle or a spray nozzle.

27. The method according to claim 18, wherein the medium is introduced parallel to the longitudinal axial direction of the filter segments or the filter rods.

28. The method according to claim 18, wherein the medium is introduced into at least one hollow space in a multifilter segment or a multifilter rod.

29. A module for a multi-segment filter maker in the tobacco-processing industry, wherein filter segments or filter rods can be delivered to form a group of filter segments and a device is provided for introducing a medium into the filter segments or filter rods.

30. The module of claim 29, wherein the module comprises a device for introducing a medium into filter rods or filter segments, and a cutting device for cutting the filter rods into filter segments.

31. The module according to claim 29, wherein the device forms a part of a conveying means, said conveying means comprising a conveying drum or an operating drum.

32. The module according to claim 29, wherein the module comprises a holding element for holding the filter rods or the filter segments against the operating drum.

33. The module according to claim 29, wherein the device comprises a spray nozzle or a spray needle for introducing the medium to the filter rods or filter segments.

34. The module according to claim 33, wherein the injection element is subjected to pressure by a compressed-air source or a piston.

35. The module according to claim 29, wherein a metering device is provided for the medium.

36. A multi-segment filter maker in the tobacco-processing industry, comprising a the device of claim 29.

37. The module of claim 29, wherein additional filter rods or filter segments are delivered to the group of formed filter segments.
